(19) United States
(12) Patent Application Publication
(10) Pub. No.: US 2013/0173499 A1
(43) Pub. Date: Jul. 4, 2013

(54) ROBUST CLOUD COMPUTING E-DISCOVERY PLATFORM

(71) Applicant: Craig D. Cannon, Winston Salem, NC (US)

(72) Inventor: Craig D. Cannon, Winston Salem, NC (US)

(73) Assignee: BANK OF AMERICA CORPORATION, Charlotte, NC (US)

(21) Appl. No.: 13/342,086

(22) Filed: Jan. 1, 2012

(51) Int. Cl. G06Q 30/02

(52) U.S. Cl. 705/400

(57) ABSTRACT

System, method, and computer program product are provided for a robust cloud computing e-discovery platform (RCCEP). The RCCEP program allows users to select different applications from different vendors for each phase of e-discovery. A cloud may be populated by vendors supplying e-discovery resources. Once the cloud is populated, users may, in some embodiments, opt-in to access the cloud. In other embodiments, the cloud may be provided to the user privately. The user may access the vendor e-discovery resources that are on the cloud based on the phase of e-discovery the user. In this way, the user may select one vendor's e-discovery resource to use for one phase of e-discovery and subsequently select a different vendor's e-discovery resource for a second phase of e-discovery. This invention provides an enterprise-wide e-discovery technology solution that encompasses the best of all vendors' systems in all phases of the e-discovery process.

### BACKGROUND

Historically, the most time consuming and costly component of any civil lawsuit has been the discovery process. The discovery process is how parties to a lawsuit obtain relevant information from each other pursuant to the governing jurisdiction's rules of civil procedure. The Federal Rules of Civil Procedure now allow for discovery of electronically stored information.

Electronic discovery, commonly referred to as e-discovery, refers to any process in which electronic data is sought, located, secured and searched with the intent of using it as evidence in a legal proceeding, an audit, a securities investigation, a forensics investigation, or the like.

The nature of electronic data makes it extremely well-suited for investigation. In particular, electronic data can be searched with ease, whereas paper documents must be scrutinized manually. Furthermore, electronic data is difficult or impossible to completely destroy, particularly if the data is stored in a network environment. This is because the data appears on multiple hard drives, and because electronic files, even if deleted, generally can be undeleted. In fact, the only reliable means of destroying electronic data is to physically destroy any and all hard drives where it is stored.

In the process of e-discovery, data of all types can serve as evidence. This can include text, image, calendar event data, databases, spreadsheets, audio files, multimedia files, web sites, and computer programs. Electronic mail (e.g., e-mail) can be an especially valuable source of evidence in civil or criminal litigation, because people are often less careful in these exchanges than in hard copy correspondence such as written memos or postal letters.

E-discovery is an evolving field that goes far beyond mere technology. It involves several phases, each phase may give rise to multiple issues, many of which have yet to be resolved. For example, identifying data required to satisfy a given discovery request, collecting the appropriate set of data that has been identified, preserving the data once it has been collected, etc., are all phases that pose problems in and of themselves. This is especially evident if the data that is being identified, collected, preserved, etc., by a single technology system that encompasses a program for each phase, provided by a single vendor.

Several vendors provide resources that encompass the different technology programs or applications required for all of the phases of the e-discovery process. However, these vendors provide the technology in a fix asset model. In order for a user to utilize the resources available for each phase from a particular vendor, the vendor requires the user to purchase the entire resource package. Therefore, the user must use the program or application from that vendor for each phase of e-discovery, unless the user wishes to purchase multiple resource packages from multiple vendors, which can be very costly. However, these vendors typically specialize in only one or two phases of e-discovery, while that vendor may be specialized in one phase of e-discovery, the vendors resources may be unsatisfactory for the user in another phase. For example, although a vendor's resource package may have a program that provides best-in-class identification functionality for the user's e-discovery needs, the same resource package may have a program that does not provide the features required by the user for the collection phase of e-discovery.

Because of this, it is challenging for users wishing to get programs that match the user's needs in all phases of e-discovery, without paying for several different vendor provided resource packages.

Therefore, a need exists to improve the availability of specialized phases of e-discovery to users, without the user having to sacrifice the quality of other phases of the e-discovery.

### BRIEF SUMMARY

Embodiments of the present invention address these and/or other needs by providing apparatuses (e.g., a system, computer program product and/or other devices) and methods for providing a robust cloud computing e-discovery platform (RCCEP), thus allowing users to select different programs from different vendors for each phase of the e-discovery process. Therefore providing an enterprise-wide e-discovery technology solution that encompasses the best of all vendors' systems in all phases of the e-discovery process.

In some embodiments, a user may opt-in to using the RCCEP program. In other embodiments, the user may search the e-discovery platform and select the programs within the platform without first opting into the program.

In some embodiments, prior to the user gaining access to the cloud, vendors may populate the cloud by adding vendor resources to it. Vendor resources include e-discovery technology data provided by a vendor, such as, but not limited to systems, applications, programs, interfaces, packages, and the like. Vendor resources further comprise the updates, patches, programs, etc. required to utilize the e-discovery technology from a vendor for e-discovery. Vendors that populate the cloud with vendor resources may access the cloud in order to provide new vendor resources, update vendor resources, provide compatibility for vendor resources, and/or the like. The vendor resources may populate the cloud and be searchable by e-discovery phase. In this way, the user may search for various vendor resources based on the phase of e-discovery that the user may require resources.

Once the cloud is populated, a user may be able to access the cloud. In some embodiments, the user may opt-in to access the cloud. The user may opt-in via the Internet, visiting a financial institution, text messaging, voice messaging, accessing an interface, a mobile application, or the like. In some embodiments, the user may request to access the contents of the cloud. In other embodiments, the cloud may be publically available to any users require e-discovery resources, thus not requiring an opt-in from the user. In yet other embodiments, the cloud may be privately accessed by a user, through the use of a user node. In still other embodiments, the cloud may be accessed through a user silo, which may be a portion of the cloud designated specifically for that user and that user's data.

In some embodiments, the user may then access the cloud. Accessing the cloud allows a user to have access to and utilize any of the vendor resources available on the cloud. In this way, the user may be able to select a different vendor for each phase of the e-discovery process. For example, a user may select a program from Vendor 1 to utilize for the first phase of e-discovery, but select a program from a different vendor, Vendor 2 to use for the second phase of e-discovery. In this way, the user may use different programs from different vendors for different phases of e-discover, instead of having to use one vendor for all phases of e-discovery.

In some embodiments, accessing the cloud allows the user to access and run the vendor resources populating the cloud via the processing capabilities of the cloud. In other embodiments, accessing the cloud allows the user to access and run the vendor resources populating the cloud via the processing capabilities of the user's computing device. In yet other embodiments, accessing the cloud allows the user to access and run the vendor resources populating the cloud via a separate server or user node. In still other embodiments, accessing the cloud allows the user to access and run vendor resources populating the cloud via a user silo located on the cloud.

In some embodiments, the user may store electronic data or electronic data sets generated from using vendor resources on the cloud, on a user silo within the cloud, on a user node, or on a user computing device. The stored electronic data or stored electronic data sets may be later accessed and utilized with other vendor resources from the same vendor or different vendors for subsequent phases of e-discovery. In this way, the stored electronic data or electronic data sets may be compatible across both processors and vendor resources. For example, if a user uses the vendor resources from Vendor 1 for the first phase of e-discovery, the user may be able to access and apply any electronic data created from that phase of e-discovery and use it in the next phase of e-discovery irrespective of whether the user selects to use vendor resources from Vendor 1 for that phase. Furthermore, the electronic data or electronic data sets may be accessible across various mediums. For example, if the user uses his/her how computing device to access and run the vendor resources for a phase of e-discover, the user may be able to access the electronic data set created from that phase utilizing the processing capabilities of the cloud, a user node, a silo, or a user computing device.

Once the user has accessed the cloud, he/she may be able to search for vendor resources based on the phase of e-discovery the user is wishing to use the RCCEP program. In this way, the user may be able to find all the vendor resources from all the vendors that populated the cloud based on the particular project and phase of e-discovery the user is currently in. The user may also be able to receive descriptions, functions, brief free trial periods, etc. for each of the vendor resources on the cloud. In this way, the user may be able to select the appropriate vendor resource, such as an application or program, for the e-discovery phase. In some embodiments, the user may be able to store the date the user has compiled for e-discovery on the cloud, such that the user may utilize the data he/she has stored on the cloud in conjunction with the vendor resources available on the cloud.

Once the user completes his/her use of the vendor's resource for the phase of e-discovery, the user may pay for the use of the resource. The fees associated with the user's use of the vendor resources may in some embodiments, be established by the vendor. In other embodiments, the host of the RCCEP program may establish the fees to charge a user. In this way, the host of the RCCEP program may establish a payment agreement with the vendor, prior to charging the user for use of the vendor resources of the RCCEP program. When the vendor is allowed to set fees for the user, the vendor may determine the fees based on several factors. In some embodiments, the vendor may change a user based on the use of the vendor's resources. In some embodiments, the vendor may charge a user a fixed fee for using the vendor's resources. In this way, for example, a user may pay a monthly fixed fee for the use of the cloud. This may be beneficial to users, such as businesses, law firms, and the like that may require a specific e-discovery budget. Therefore, with this fee model the user may be able to budget the cost associated with e-discovery per month accurately. In yet other embodiments, the vendor may charge a user 202 based on the amount of time the user 202 uses the vendor's resources. When the host of the RCCEP program establishes the fees to charge the user 202, the vendor will not directly charge the user 202 for use of the vendor resources. In this way, the user 202 may be charged a set fee from the RCCEP system host, such as a financial institution, based on the user's 202 use of the RCCEP program. The fee may then be distributed back to the vendors that populated the cloud 201 with vendor resources.

In some embodiments, the use may continue to use the RCCEP program for his/her e-discovery needs by subsequently selecting another vendor resource for the next phase of e-discovery. In this way, the user may be able to accumulate his/her own custom bundle of resources for use during e-discovery. Some of the resources from the user's custom bundle may be from one vendor, while other resources may be from another vendor. The user, in some embodiments, may continue to change the vendor resources that the user uses during e-discovery based on the user's e-discovery needs.

Embodiments of the invention relate to systems, methods, and computer program products for receiving e-discovery resources at a platform, wherein the e-discovery resources are provided to the platform by vendors; populating the platform with e-discovery resources based at least in part on a phase of e-discovery associated with the resource; receiving an indication that the user is initiating in an e-discovery phase; providing the user with access to the platform, based at least in part on the user initiating an e-discovery phase, wherein the user may access the e-discovery resources available on the platform; allowing the user to select e-discovery resources on the platform based on e-discovery phase; and determining a fee for the user's use of the platform and e-discovery resources available on the platform.

In some embodiments, the phases of e-discovery address one or more of identification, collection, preservation, review, and product of electronic data for use in a lawsuit.

In some embodiments, providing the user with access to the platform further comprises establishing a private platform wherein only the user has access to the e-discovery resources populating the platform. Furthermore, the electronic data created by the user when the user accesses the e-discovery resources available on the platform may be stored on the platform. The platform comprises a cloud, wherein the cloud allows for on-demand access to a shared pool of e-discovery resources. In some embodiments, a financial institution hosts the cloud.

In some embodiments, the system may allow the user to select an individual e-discovery resource for a first phase of e-discovery based on the phase of e-discovery and allow the user to select an individual e-discovery resource for a second phase of e-discovery independent of the e-discovery resource selected for the first phase of e-discovery.

In some embodiments, the system may allow the user to select an individual e-discovery resource from the platform, wherein the e-discovery resource is from a first vendor; and allow the user to select a second individual e-discovery resource from the platform, wherein the e-discovery resource is from a second vendor. In some embodiments, the user may be0 a party of a lawsuit requiring e-discovery. In other embodiments, the user may be a representative of a party of a lawsuit requiring e-discovery.

In some embodiments, the e-discovery resources further comprise applications that assist the user in one or more phases of e-discovery. In other embodiments, the e-discovery resources further comprise programs that assist the user in one or more phases of e-discovery.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the process of using the robust cloud computing e-discovery platform, in accordance with embodiments of the invention;

FIG. 2 is a combination flowchart and block diagram illustrating the phases of e-discovery, in accordance with example embodiment of the invention;

FIG. 3 provides a robust cloud computing e-discovery system environment, in accordance with various embodiments of the invention;

FIG. 4a provides a private but external deployment method of the robust cloud computing e-discovery system environment, in accordance with an embodiment of the invention;

FIG. 4b provides a hybrid method of the robust cloud computing e-discovery system environment, in accordance with an embodiment of the invention;

FIG. 5 provides a process map illustrating a user's navigation of the robust cloud computing e-discovery platform, in accordance with an embodiment of the invention; and

FIG. 6 provides a process map illustrating vendor access and use of the robust cloud computing e-discovery platform, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “electronic data” as used herein includes any information electronically stored or produced. For example, electronic data may include, but is not limited to mechanical, facsimile, electronic, magnetic, digital or other programs (private, commercial, work-in-progress, etc.), programming notes, instructions, listings of electronic mail receipts, output resulting from the use of any software program, including word processing documents, spreadsheets, database files, charts, graphs and outlines, electronic mail or “e-mail,” personal digital assistant (“PDA”) messages, instant messenger messages, operating systems, source code of all types, programming languages, linkers and compilers, peripheral drives, PDF files, PRF files, batch files, ASCII files, crosswalks, code keys, pull down tables, logs, file layouts and any and all miscellaneous files or file fragments, deleted file or file fragment. Electronic data may also include any and all items stored on computer memory or memories, hard disks, floppy disks, zip drives, CD-ROM discs, Bernoulli Boxes and their equivalents, magnetic tapes of all types and kinds, microfiche, punched cards, punched tape, computer chips (including but not limited to EPROM, PROM, ROM and RAM of any kind) on or in any other vehicle for digital data storage or transmittal, files, folder tabs, or containers and labels appended to or associated with any physical storage device associated with each original and each copy.

Furthermore, embodiments of the present invention use the term “user.” It will be appreciated by someone with ordinary skill in the art that the user may be an individual, law firm, financial institution, government organization, corporation, or other entity that may require e-discovery software. Embodiments of the present invention also use the term “vendor” to describe a company, business, individual, or other entity that provides systems and technology required for the phases of e-discovery.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

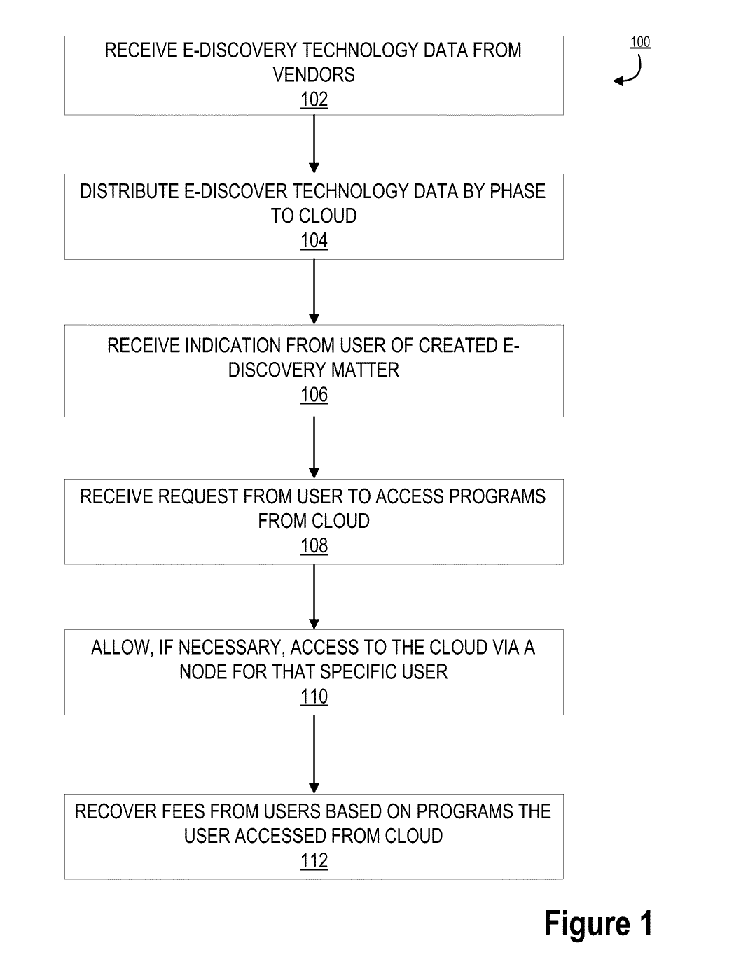

FIG. 1 illustrates a high level process flow illustrating the process of using the robust cloud computing e-discovery platform (RCCEP) 100, in accordance with embodiments of the invention. As illustrated in block 102 of the high level process flow 100, the system receives e-discovery technology data from vendors for placement on the cloud. E-discovery technology data may include systems, applications, programs, interfaces, packages, and the like that a vendor may provide to a user to allow the user to perform the operations necessary to complete any of the phases of e-discovery. E-discovery technology data and the updates, patches, programs, etc. required to utilize the e-discovery technology from a vendor for e-discovery is herein referred to as vendor resources. In some embodiments, the system may request the e-discovery technology data from the vendor. In other embodiments, the vendor may provide the system with the e-discovery technology data. In some embodiments, the e-discovery technology data from a vendor may be provided to the system based on an agreement between the system managers and the vendor. Once the e-discovery technology data has been received by the system, the system may distribute the technology data received from the vendor on the cloud based on the phase of e-discovery the data is directed to. For example, the vendor may provide e-discovery technology data in the form of a package of programs for several different phases of e-discovery. The system may then parse out the package and include each individual program on the cloud. Therefore the cloud may maintain each program individually, separate from the package, based on the phase of e-discovery the program may be utilized. In this way, a user may utilize only the program of the package that the user may wish to use for his/her e-discovery needs, without purchasing the entire package from the vendor that includes all of the vendor's programs.

As further illustrated in FIG. 1, once the cloud is populated, by e-discovery phase, with technology data from various vendors, the system receives and indication from a user that the user is creating an e-discovery matter, as illustrated in block 106. Next, in block 108, the system receives a request from the user to access programs or applications from the cloud. In this way, the user may request programs or applications from a first vendor for one phase of e-discovery and a second vendor for another phase of e-discovery.

Next, at block 110, if it is necessary for security reasons, the system may allow a user to access the cloud via a node designated specifically for that user's utilization. In other embodiments, the user may have access to the cloud via his/her own portal of the cloud, or silo, that is only accessible by that particular user or user authorized entities. Finally, as illustrated at block 112, the system may recover fees from the user based on vendors/programs the user accessed on the cloud.

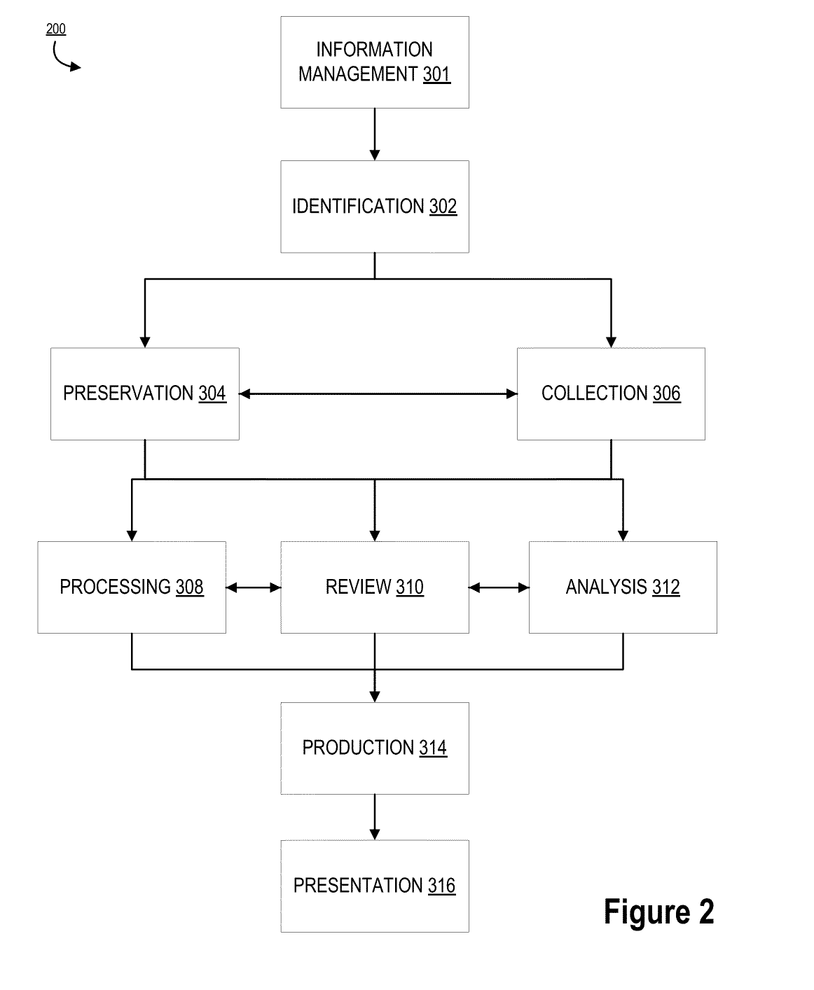

FIG. 2 illustrates, for background, the phases of e-discovery in a combination flowchart and block diagram 200. The phases of e-discovery include, but may not be limited to information management 301, identification 302, preservation 304, collection 306, processing 308, review 310, analysis 312, production 314, and presentation 316. Information management 301 is the storing and managing of electronic data. Identification 302 is the e-discovery phase of identifying and validating potentially relevant electronic data sources. Once the electronic data is identified it may be preserved or collected. Preservation 304 includes the isolation and protection of potentially relevant identified electronic data in ways that mitigate risk. Collection 306 is the e-discovery phase of collecting the relevant identified electronic data. The next phases of the e-discovery process include processing 308, review 310, and analysis 312. Processing 308 is the e-discovery phase where the collected electronic data set is reduced based on appropriateness and reduced to review 310. Review 310 is the e-discovery phase where the processed electronic data set is reviewed to determine which electronic documents are relevant to the lawsuit and which documents should be excluded. Analysis 312 is the e-discovery phase where the processed and reviewed electronic data set is analyzed for fact gathering and strategic purpose related to the lawsuit. Once the electronic data has been processed 308, reviewed 310, and analyzed the production 314 phase of e-discovery is next. Production 314 is the e-discovery phase where the electronic data that has been processed and reviewed is produced to another party involved in the lawsuit. Finally, the electronic data is presented before an audience.

As illustrated in FIG. 2, there are several phases of e-discovery. Therefore, several different specialized programs required to provide the required functions for each phase of e-discovery. Most vendors provide e-discovery technology data in a package system that includes programs or applications for all of the phases described above with respect to FIG. 2. Thus, a user will receive programs or applications for all phases of e-discovery when purchasing the e-discovery technology data system from one vendor. However, if a user wishes to receive programs or applications from a different vendor, the user may have to purchase another complete e-discovery technology data system from the second vendor. The user may wish to purchase programs from other vendors because other vendors may provide a better program for a particular phase for a particular client. For example, a user may need to have better review phase of e-discovery based on the user's lawsuit. The user may need to have a linear review, a second level review, and a privilege review. However, the vendor the user purchased a system from only provides a program for linear review and not the subsequent reviews. Thus, in order for the user to receive the second level review and privilege review aspects from the review phase, the user must purchase the complete fixed asset system from the vendor providing these reviews. Thus, the user may purchase fix asset systems from two vendors and receive programs for all aspects of the phases of e-discovery from both vendors instead of receiving just the program for the review phase from the vendor with second level and privilege review, and programs for the other phases of e-discovery from the first vendor.

The RCCEP program may eliminate the cost of purchasing one or more complete fixed asset systems from vendors by providing the user with the option of selecting the program or application that the user wishes to use for each individual phase irrespective of the vendor providing the program or application.

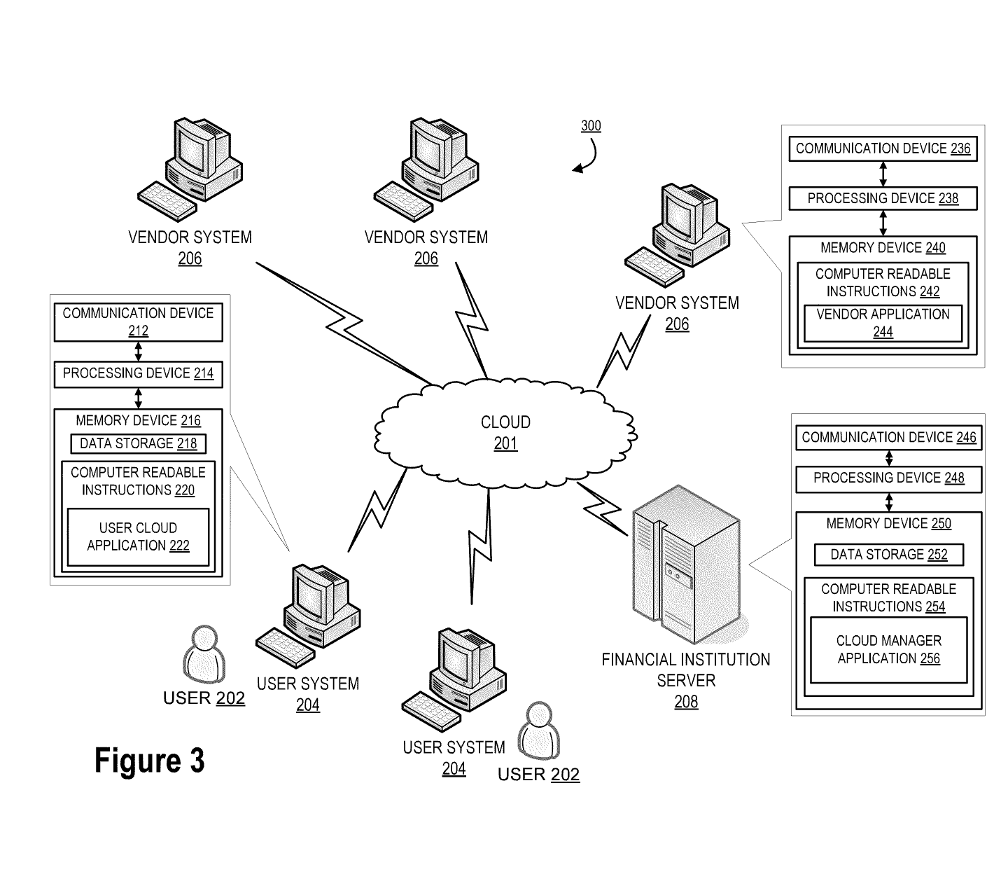

FIG. 3 illustrates a robust cloud computing e-discovery platform (RCCEP) system environment 300, in accordance with one embodiment of the present invention. As illustrated in FIG. 3, the financial institution server 208 is operatively coupled, via a cloud network 201 to the user systems 204 and to merchant systems 210. In this way, the financial institution server 208 can send information to and receive information from a user system 204 and a vendor system 206, to send and receive information pertaining to the RCCEP system. FIG. 3 illustrates only one example of an embodiment of an RCCEP system environment 200, and it will be appreciated that in other embodiments one or more of the systems, devices, or servers may be combined into a single system, device, or server, or be made up of multiple systems, devices, or servers.

The cloud 201 may allow for on-demand network access to a shared pool of configurable resources provided by either the financial institution server 208, in the form of cloud resources (e.g., networks, servers, storage, services, etc.) or provided by the vendors, in the form of vendor resources (e.g., vendor e-discovery technology data such as applications, systems, programs, packages, etc. and updates or programs to operate the same) that can be rapidly provisioned and released. The network access may be a global area network (GAN), such as the Internet, a wide area network (WAN), a local area network (LAN), or any other type of network or combination of networks. The network may provide for wireline, wireless, or a combination wireline and wireless communication between devices on the network. The vendor resources may include all e-discovery technology data such as, but not limited to programs, applications, systems, software, etc. that may be provided by a vendor for e-discovery. Furthermore, the vendor resources may include updates, patches, programs, etc. that allow a user to run the e-discovery technology data provided by the vendor.

In some embodiments, both cloud and vendor resources may be stored on the cloud 201 and not at a local computing device, such that the memory of the local computing device is not affected by the work associated with the resources on the cloud 201. Furthermore, the cloud 201 may provide processing capabilities, such that the user may run the resources on the cloud 201 and not on his/her local computing device. Therefore, the cloud 201 may store both cloud and vendor resources, providing processing capabilities for the resources, and store electronic data generated by the user using the cloud. In this way, a shared pool of cloud and vendor resources relating to e-discovery may be accessed, processed, and stored by users of the RCCEP system all within the cloud 201. Furthermore, in some embodiments, the cloud 201 may store user data. This user data may be used by a user during the e-discovery process, this data may include any data that the user has compiled, generated, or the like for e-discovery.

The cloud 201, in some embodiments, may take the form of several different models as required by the managing entity of the cloud 201. These models may include, but are not limited to private model, public model, community model, and hybrid model. In some embodiments, the cloud 201 may be provided in a private model. The private model allows the cloud 201 to only be used only be a single entity. In some embodiments, the cloud 201 may be provided in a public model. The public model allows the cloud 201 to be available to the public or to multiple entities. In some embodiments, the cloud 201 may be provided in a community model. The community model allows the cloud to be accessed and/or used by a group of related entities. In some embodiments, the cloud 201 may be provided in a hybrid model. In the hybrid model the cloud 201 may be used both publicly and privately based on the provider's requests.

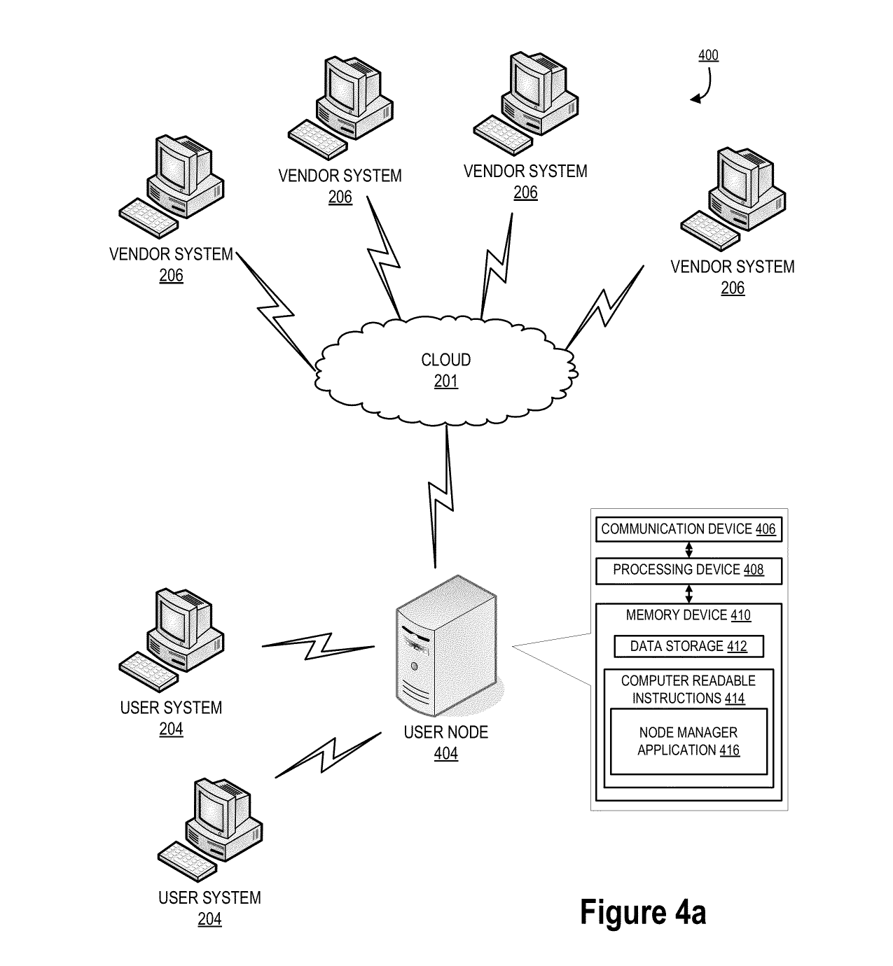

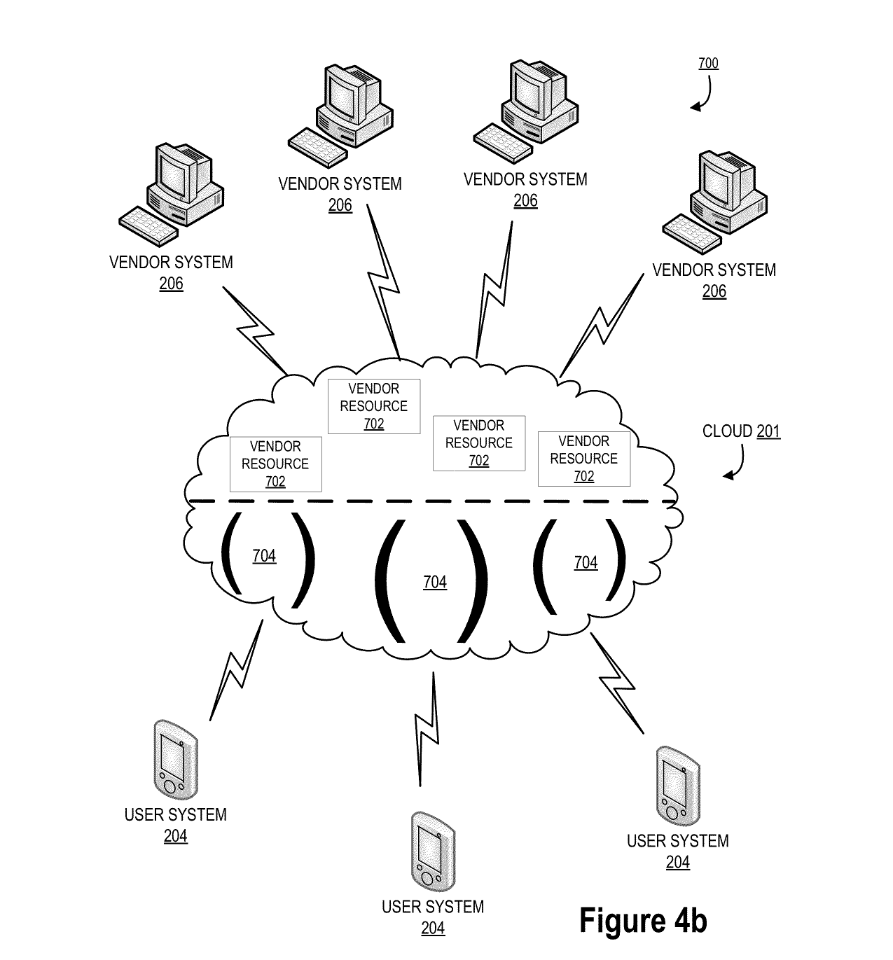

The various models of the cloud 201 may each be utilized for the RCCEP system. However, some models may require more security monitoring than others. For example, in the public model, a larger number of users may access the cloud 201 and therefore there is more likely going to be a security issue, simply based on the number of individuals who have access to the cloud 201 and the data or applications located on the cloud 201. In some embodiments, a private cloud 201 may provide the most security protection to the financial institution and other users of the cloud 201. Furthermore, a private but external deployment cloud 201, which is further illustrated in FIG. 4a below, may provide added security features for the user, the vendor, and the provider of the RCCEP system. In other embodiments, the cloud 201 may be a hybrid cloud 201, such as that illustrated in FIG. 4b. In this way, the user may have access to the vendor resources on the cloud 201 through the user's own silo. Therefore, the user's silo may be secure, but other users may be able to access the same vendor resources that are on the cloud 201 without the need to provide a private but external deployment cloud 201.

In some embodiments, the user 202 is an individual. The individual may be an attorney or party of a lawsuit. In other embodiments, the user 202 may be a law firm, financial institution, government organization, corporation, or other entity requiring e-discovery needs. The user 202 may wish to retrieve vendor resources off of the cloud 201 for use in e-discovery. In some embodiments, the user 202 may have previously opted in to gain access to the cloud or node associated with the user 202. In other embodiments, the user 202 may access a public cloud 201 for e-discovery purposes. In yet other embodiments, a user 202 may access a cloud 201 on behalf of another entity. In some embodiments, a single user 202 may be accessing the cloud 201 at any particular time. In yet other embodiments, multiple users 202 may be accessing the cloud 201 at any particular time. In the example illustrated in FIG. 3, there are two users 202 accessing the cloud through their user systems 204.

As illustrated in FIG. 3, the financial institution server 208 generally comprises a communication device 246, a processing device 248, and a memory device 250. As used herein, the term “processing device” generally includes circuitry used for implementing the communication and/or logic functions of the particular system. For example, a processing device 248 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the cloud 201 and other devices associated with the cloud 201, such as, but not limited to the user systems 204 and the vendor systems 206. As such, the communication device 246 generally comprises a modem, server, or other device for communicating with the cloud 201 and other devices associated with the cloud 201.

As further illustrated in FIG. 3, the financial institution server 208 comprises computer-readable instructions 254 stored in the memory device 250, which in one embodiment includes the computer-readable instructions 254 of a cloud management application 256. In some embodiments, the memory device 250 includes data storage 252 for storing data related to the financial institution and the management of the cloud 201 including but not limited to data created and/or used by the cloud management application 256.

As described in more detail below, the financial institution server 208 may provide for the management of the RCCEP system 300, the financial institution server 208 or other server managing or hosting the RCCEP system 300 may be technology agnostic and will not have a vested interest in the success or failure of any of the vendor resources on the cloud 201.

In the embodiment illustrated in FIG. 3 and described throughout much of this specification, the cloud management application 256 manages the resources and activity on the cloud 201. The cloud management application 256 provides managerial applications for both vendor and user 202 aspects of the cloud 201. The cloud management application 256 allows for vendors to provide resources to the cloud 201, organizes the vendor's resources on the cloud 201, allows for vendors to update resources, allow for compatibility of vendor's resources with user systems 204, enables the vendor to monitor its resources on the cloud, manages fees, and the like. The cloud management application 256 allows for the user 202 to access the cloud 201, set up user nodes 404, provides silos for users 202 on the cloud 201, select programs or applications on the cloud 201, use the vendor resources, store preferences, create and store electronic data, create and store electronic data sets, or the like.

The cloud management application 256, in some embodiments, allows a vendor to provide resources to the cloud 201. In this way, the vendor may seek out and request from the cloud management application 256 for the vendor's resources to be added to the cloud 201. In other embodiments, the cloud management application 256 may seek out vendors and request the vendor add resources to the cloud 201. In still other embodiments, a vendor may provide the cloud 201 with resources independent of any action by the financial institution server 208 or the cloud management application 256. In this way, the vendor may have several avenues to provide the cloud 201 with e-discovery technology data and other resources that the particular vendor may provide for e-discovery.

Once the vendor has provided its resources to the cloud 201 the cloud management application 256 may separate the vendor resources by e-discovery phase. The vendor resources, comprising several individual programs, applications, software, or the like from a vendor, may be distributed on the cloud 201 and stored in the financial institution server 208, or user node 404 based on e-discovery phase. In this way, the cloud management application 256 separates the vendor e-discovery technology data packages into individual programs, applications, software, or the like and provides the individual program, application, or software on the cloud 201 based on the phase of e-discovery that that individual program, application, or software is associated with. In this way, each vendors' individual program, application, or software comprising the vendors' resources are organized on the cloud 201 based on the e-discovery phase such that the individual aspects of the vendors resources are easily searchable by the user 202.

Next the cloud management application 256 provides the vendor with the ability to update the vendor's resources. If the vendor develops new resources, such as updated software, applications, packages, programs, or the like, the cloud management application 256 allows a vendor to update the resource on the cloud 201. In some embodiments, the vendor may automatically update the vendor's resources on the cloud 201 by accessing the cloud 201 via a vendor system 206. In other embodiments, the cloud management application 256 may request the vendor update its resources on the cloud 201. In this way, the vendor, either through the vendor system 206 or other means may update the software, programs, applications or other resources the vendor has on the cloud 201, such that users 202 may have access to the latest versions of the vendor's resources.

The cloud management application 256 may also provide cloud resources that allow a user 202 to compatibly access the vendor resources on the cloud 201. In this way, the user 202 may have access to the best available e-discovery technology data for each phase of the e-discovery process. As such, the cloud management application 256 allows for the cloud 201 to support all leading e-discovery vendor resources. The cloud resources allow a user 202 to operate the vendor resources on the cloud 201 or on the user system 204. These cloud resources may include programs, software, systems, or the like that aid in providing a cloud 201 that is compatible with all vendor systems 206, vendor resources, and user systems 204 such that a vendor or a user 202 may operate any cloud or vendor resources on the cloud 201 or on a local computing device.

Along with providing compatibility requirements for the RCCEP system 300, the cloud management application 256 allows for vendors to update the vendor resources on the cloud 201. In this way, the cloud management application 256 allows for an open architecture environment for the vendors to have the ability to install update, fix bugs, implement new versions, etc. of the vendor resources. In some embodiments, the cloud 201 may update the vendor resources without the vendor accessing the cloud 201. In this way, the cloud 201 may search the vendors and actively seek out updates for the vendor resources to the cloud 201. In some embodiments, the vendor may provide the cloud 201 with updates to the vendor's resources. In this way, when the vendor adds an update to the vendor's resources, such as an update to programs or applications associated with e-discovery. In this way, the vendor, through the vendor system 206 may access the cloud 201 and provide updates to the program or application for e-discovery.

The cloud management application 256 also allows the vendor to access the cloud 201 via vendor systems 206 to monitor its resources that are on the cloud 201. Monitoring of the resources on the cloud 201 allow a vendor to determine which programs users 202 prefer from the vendor. In this way, the vendor may be able to determine which programs may need to be updated or which programs the users 202 are satisfied with. Furthermore, monitoring the resources on the cloud allow the vendor to accurately assess and manage fees. In some embodiments, the RCCEP system may contract with vendors to provide the vendors with payment for providing the vendor's resources on the cloud 201. In some embodiments, the user 202 may provide payment to the vendor directly, based on the user's 202 use of the vendor resources. The ability to monitor the activity of the vendor's resources on the cloud 201 allow the vendor to determine the popular resources the vendor may provide and allows the vendor to seek adequate fees for the use of the resources.

The cloud management application 256 may also manage the fees associated with the cloud 201. In some embodiments, the vendor may be allowed to set fees for the user 202 for use of the vendor's resources on the cloud 201. In other embodiments, the RCCEP system, through the host of the system, may set fees for the user 202 for use of the cloud 201. When the vendor is allowed to set fees for the user 202, this may be done in several ways. In some embodiments, the vendor may change a user 202 based on the user's use of the vendor's resources. In some embodiments, the vendor may charge a user 202 a fixed fee for using the vendor's resources. In yet other embodiments, the vendor may charge a user 202 based on the amount of time the user 202 uses the vendor's resources.

In some embodiments, the cloud management application 256, through the host of the cloud 201, may charge the user 202 for use of the cloud. Therefore the vendor would not charge the user 202 for use of the vendor's resources. In this way, the user 202 may be charged a set fee from the RCCEP system host, such as a financial institution, based on the user's 202 use of the cloud 201. The fee will then be distributed back to the vendors that populated the cloud 201 with vendor resources. In this way, the user 202 may be charged a flat fee for all use of the cloud 201 and deal with one billing source instead of multiple vendors billing the user 202 for the use of the vendor's resources on the cloud 201. Because this is a single flat fee payment arrangement for a user 202 this may be the preferred method of payment for a user 202 accessing the cloud 201.

In some embodiments, the fix fee for a user's monthly use of the cloud 201 may be the most beneficial to law firms, corporations, and other entities that are required to provide annual budget data for e-discovery. E-discovery costs may change vastly from year to year in the budgeting for an entity, such as a business, corporation, merchant, manufacturer, or the like. Once year, the entity may have several high-priced lawsuits requiring extensive investments into e-discovery, while the next year the entity may not have any lawsuits requiring extensive e-discovery. The fixed fee payment model for the RCCEP system allows an entity to accurately predict the funding required for that year's e-discovery, irrespective of how many lawsuits the entity is involved in that require extensive e-discovery.

Furthermore, the vendors may be charged a fixed cost associated with the management of the RCCEP system. In this way, the fees associated with creating, storing data, updating, maintaining, and running the cloud 201 may not rest directly on the financial institution providing the cloud 201, but instead may be distributed among the vendors that populate the cloud 201 with vendor resources. The fixed fee may be charged monthly and/or yearly and may vary depending on the vendor activity on the cloud 201.

The cloud management application 256 also allows for processing of the vendor resources. In some embodiments, the vendor resources may be used by the user 202 via the processing capabilities of the cloud 201. In some embodiments, the vendor resources may be used by the user 202 via the processing capabilities of the financial institution server 208. In still other embodiments, the vendor resources may be used by the user 202 via the processing capabilities of the user system 204. In this way, the user 202 may utilize the functionality of the vendor resources via the processing capabilities of several different computing platforms, such as, but not limited to the cloud 201, vendor systems 206, user systems 204, financial institution servers 208, user nodes 404, and/or other devices with processing capabilities.

The cloud management application 256 may also allow for storage of the vendor resources. In some embodiments the vendor resources may be stored on the cloud 201. In some embodiments, the vendor resources may be stored in the memory device 250 of the financial institution server 208. In yet other embodiments, the vendor resources may be stored on the user system 202. In this way, the RCCEP system may allow a user 202 to access, use, and store the resources on the cloud 202, financial institution server 208, user node 404, or user system 204. Along with the vendor resources the cloud management application 256 may also store applicable software for resource compatibility, requests from users 202 to utilize the vendor resources, data established by the user's use of the RCCEP system, electronic data sets that the user 202 may wish to be saved during the e-discovery process, and the like.

The cloud management application 256, in some embodiments, also allows the user 202 to gain access to the cloud 201. In this way, the user 202 may seek out and request from the cloud management application 256 any of the vendor resources on the cloud 201. The user 202 may be a law firm, financial institution, government organization, corporation, or other entity requiring e-discovery needs. In some embodiments, the user 202 may have previously opted in to gain access to the cloud 201. In other embodiments, the user 202 may access a public cloud 201 for e-discovery purposes without opting in to access the cloud 201. In yet other embodiments, a user 202 may access a cloud 201 on behalf of another entity.

Once the user 202 has gained access to the cloud 201, the user 202 may have access to the vendor resources on the cloud 201. The user 202 may search the cloud 201 for vendor specific, e-discovery phase specific, or need specific vendor resources. In this way, the user 202 may be able to find the exact program or application the user 202 desires to use for his/her e-discovery requirements, irrespective of whether the user 202 has purchased other e-discovery technology from that particular vendor for other phases of e-discovery. For example, the user 202 may select one program from one vendor for the collection phase of e-discovery and a different program from a second vendor for the review phase of e-discover. Therefore, the user 202 may be able to select individual programs, applications, etc. for each phase of the e-discovery process irrespective of the vendor for that program. In this way, the user 202 is not required to purchase the vendor's entire e-discovery technology data package, but instead, may select a single program or application from that package to utilize for a phase of e-discovery. Therefore, the user 202 may create his/her unique bundle of programs or applications from various vendors in order to satisfy the user's specific e-discovery needs.

In some embodiments, the user 202 may utilize the computer processing capabilities of the cloud 201 and run all vendor resources on the cloud. In this way, the user 202 may utilize the cloud 201 computing capabilities to run the programs or applications the user 202 selects for each phase of the e-discovery process. In this way, the user 202 may not have to utilize the processing capabilities of his/her local computer to complete the e-discovery phases, but instead may use the cloud 201 processing capabilities. In other embodiments, the cloud management application 256 may allow a user 202 to utilize his/her local computer, such as the user system 204, to run the programs or applications the user 202 selects for each phase of the e-discovery process. In this way, the user 202 may select the vendor application the user 202 wishes to utilize for that particular phase of e-discovery and subsequently run the application on the user system 204. This allows a user 202 the ability to run an application without necessarily having to be connected to the cloud 201.

The cloud management application 256 also allows the user 202 to store preferences, electronic data, electronic data sets, or the like on the cloud 201. In this way, the user 202 may store all the data the user 202 provides or creates using vendor resources on the cloud 201. For example, the user 202 may use one vendor's application for the analysis phase of e-discovery. However, prior to the analysis phase of e-discovery the user 202 may have already completed an identification, collection, and review phases. To perform each of these phases, the user 202 may have selected a different application from a different vendor. After each phase the user 202 may have stored an electronic data set that was generated from that phase. The user 202 may then select the created electronic data set to utilize during the analysis phase. Instead of storing each data set established during each phase of e-discovery on the user system 204, the user 202 may elect to store the data set on the cloud 201. In this way, the data sets established at each phase of e-discovery may not take up the memory of the user system 204, but instead be stored on the cloud 201. In some embodiments, the cloud 201 may store the user data sets within a user 202 silo within the cloud 201. The silo may provide storage for the user's data and also provide security, by allowing only the user 202 or entities associated with the user 202 access to the silo. In other embodiments, the user 202 may store preferences, electronic data, electronic data sets, or the like on the user system 204.

The user 202, through the cloud management application 256 may be able to access the cloud 201 and the user's data on the cloud 201 in real-time. For example, the user 202 may be able to access the cloud 201 via a mobile device. In this way, the user 202 may be able to search data that the user 202 has stored on the cloud 201, such as data sets for a specific phase of e-discovery. The user 202 may be able to search these data sets and utilize the vendor resources in real-time. For example, if a user 202 is in a deposition and a topic comes to light that the user 202 is unaware of, the user 202 may be able to search the data on the cloud 201 in real-time in order to determine information about the topic.

Along with managing the resources and activity on the cloud 201 the cloud management application 256 also provides for a mitigation of some risks associated with cloud computing. The cloud management application 256 may mitigate some risks by limiting immature resources on the cloud 201, providing clear pricing structure for use of the resources on the cloud 201, and further providing auditing capabilities of the cloud 201.

FIG. 3 further illustrates a vendor system 206 generally comprises a communication device 236, a processing device 238, and a memory device 240. The processing device 214 is operatively coupled to the communication device 236 and the memory device 216. The processing device 238 uses the communication device 236 to communicate with the cloud 201 and other devices connected to the cloud 201, such as, but not limited to the financial institution server 208 and the user systems 204. As such, the communication device 236 generally comprises a modem, server, or other device for communicating with the cloud 201 and the other devices on the cloud 201.

As further illustrated in FIG. 3, the vendor system 206 comprises computer-readable instructions 242 stored in the memory device 240, which in one embodiment includes the computer-readable instructions 242 of a vendor application 244. In this way, in some embodiments, a vendor may be able to provide resources to the cloud 201, organize resources on the cloud 201, update resources on the cloud 201, monitor vendor resources on the cloud 201, manages fees, and the like using the vendor application 244. In some embodiments, the memory device 240 includes data storage for storing data related to the vendor system 206 including but not limited to data created and/or used by the vendor application 244.

The vendor application 244 allows a vendor to provide resources to the cloud 201 using a vendor system 206. In this way, the vendor may be able to populate the cloud 201 with resources by using any vendor system 206. Once the vendor has been accepted by the host of the RCCEP system to provide resources to the cloud 201, the vendor may be able to populate the cloud 201 using a vendor system 206 connected to the cloud 201. Furthermore, the vendor application 244 allows the vendor the ability to organize the vendor's resources on the cloud 201, such that the vendor may be able to provide designate phases of e-discovery for individual programs or applications. In this way, the user 202 may be able to search for the vendor's resources by e-discovery phase or the like.

The vendor application 244 further allows the vendor to access the cloud 201 to update and monitor the vendor's resources on the cloud 201. In this way the vendor, through the use of the vendor system 206 may access the cloud 201 such that the vendor may provide the latest updates to the resources that the vendor may have previously provided to the cloud 201. In this way, the user 202 may have access to the most updated version of the vendor's resources. Furthermore, the host of the cloud 201 may not have to provide the updates to the vendor resources on the cloud 201, the vendor may be able to access the cloud 201 and independently provide updates to the vendor's resources on the cloud 201.

FIG. 3 depicts only three vendor system 206 within the RCCEP system environment 300, however, one of ordinary skill in the art will appreciate that a plurality of vendor systems 206 may be communicably linked with the cloud 201 and the other devices on connected to the cloud 201, such that each vendor who may wish to provide vendor resources to the cloud 201 is able to do so and is communicably linked to the cloud 201 and the other devices on the cloud 201.

FIG. 3 also illustrates a user system 204. The user system 204 generally comprises a communication device 212, a processing device 214, and a memory device 216. The processing device 214 is operatively coupled to the communication device 212 and the memory device 216. The processing device 214 uses the communication device 212 to communicate with the cloud 201 and other devices, such as, but not limited to the financial institution server 208 and the vendor systems 206. As such, the communication device 212 generally comprises a modem, server, or other device for communicating with the cloud 201 and the other devices connected to the cloud 201.

As further illustrated in FIG. 3, the user system 204 comprises computer-readable instructions 220 stored in the memory device 216, which in one embodiment includes the computer-readable instructions 220 of a user cloud application 222. In this way, in some embodiments, a user 202 may be able to opt-in to the RCCEP program, access the cloud 201, set up user nodes 404, select programs or application on the cloud 201, use the vendor resources on the cloud 201, create and store preferences, create and store electronic data, create and store electronic data sets, and/or the like using the user cloud application 222. In some embodiments, the user cloud application 222 allows a user 202 to utilize the vendor resources via the processing device 214 of the user system 204. In this way, the user 202 may create and store electronic data or electronic data sets on the user system 204 utilizing the vendor resources that may be pulled off the cloud 201 and used on the user system 204. In this way, the user system 204 may provide the processing capabilities to run vendor resources, create electronic data sets when running vendor resources, and store electronic data established when running vendor resources. In some embodiments, the user 202 may utilize the cloud's processing capabilities to run vendor resources, create electronic data sets when running vendor resources, and store electronic data established when running vendor resources.

In some embodiments, the memory device 216 includes data storage 218 for storing data related to the user system 204 including but not limited to data created and/or used by the user cloud application 222. A “user system” 204 may be any communication device, including mobile devices (as further illustrated in FIG. 4b) such as a cellular telecommunications device (e.g., a cell phone or mobile phone), personal digital assistant (PDA), a mobile Internet accessing device, or other user system including, but not limited to PDAs, pagers, televisions, gaming devices, laptop computers, desktop computers, cameras, video recorders, audio/video player, radio, GPS devices, any combination of the aforementioned, or the like.

FIG. 3 depicts only two user systems 204 within the RCCEP system environment 300, however, one of ordinary skill in the art will appreciate that a plurality of user systems 204 may be communicably linked with the cloud 201 and the other devices on connected to the cloud 201, such that each user 202 who may wish to access the vendor resources on the cloud 201 is able to do so and is communicably linked to the cloud 201 and the other devices on the cloud 201.

It is understood that the servers, systems, and devices described herein illustrate one embodiment of the invention. It is further understood that one or more of the servers, systems, and devices can be combined in other embodiments and still function in the same or similar way as the embodiments described herein.

Since cloud computing technology is relatively new, there is some risk associated with its adoption. The primary risk is that the cloud 201 does not provide adequate security safeguards. This is due to the amount of users 202 and other potential third parties that may be able to access the cloud 201. Additional risks may include immaturity of resources on the cloud 201, a lack of clarity with respect to pricing of the resources on the cloud 201, industry instability, lack of auditing capability, and internal information technology resistance to cloud computing. In order to better provide adequate security safeguards, in some embodiments, the cloud 201 is provided in a private but external deployment method, as illustrated in FIG. 4a. In other embodiments, the cloud 201 may be provided in a hybrid deployment method, as illustrated in FIG. 4b.

FIG. 4a illustrates a private but external deployment method of the robust cloud computing e-discovery system environment 400, in accordance with an embodiment of the invention. As illustrated in FIG. 4a, an external but private RCCEP system environment 400 provides vendor resources, such as programs and applications, contained within the cloud 201 to reside outside of the cloud host system's firewall. In this way, the vendor and cloud resources may reside on a user node 404 outside a host system's firewall. The security risks associated with vendor resources reside outside a host firewall, such as the risk of third party gaining access to the RCCEP system, may be minimized because each user 202 may have private access to its own dedicated user node 404.

As illustrated in FIG. 4a, vendor systems 206 provide the e-discovery technology data, in the form of vendor resources, required for all of the phases of the e-discovery process to the cloud 201, as further described above with respect to FIG. 3. Once the vendor systems 206 provide the programs, the implementation of the RCCEP program may be in an external, but private cloud environment. Like illustrated above with respect to FIG. 3, the cloud 201 may reside outside of the financial institution server's 208 firewall. Vendor resources, such as programs and applications on the cloud 201 may be retrieved and stored on a user node 404. The user node 404 may be its own dedicated RCCEP server such that the user 202 may have private access to the cloud 201 via the user node 404. In this way, the cloud 201 and data stored thereon is more secure because access to the cloud 201 requires going through a private user node 404.

The user node 404 generally comprises a communication device 406, a processing device 408, and a memory device 410. The processing device 408 is operatively coupled to the communication device 406 and the memory device 410. The processing device 408 uses the communication device 406 to communicate with the cloud 201 and other devices, such as, but not limited to the user system 204 and the vendor systems 206. As such, the communication device 406 generally comprises a modem, server, or other device for communicating with the cloud 201 and the other devices connected to the cloud 201.

As further illustrated in FIG. 4a, the user node 404 comprises computer-readable instructions 414 stored in the memory device 410, which in one embodiment includes the computer-readable instructions 414 of a node manager application 416. In this way, in some embodiments, a user 202 may be able to securely log-in to the user node 404 designated specifically for that user 202, access vendor resources from the cloud 201 directly onto the user node 404, create electronic data and data sets utilizing the vendor resources, store the created electronic data and data sets, and/or the like using the node manager application 416. In some embodiments, the memory device 410 includes data storage for storing data related to the user node 404 including but not limited to data created and/or used by the node manager application 416.

The node manager application 416 allows a user 202 to privately access the cloud 201. In some embodiments, the node manager application 416 allows a user 202 to use the processing device 408 of the user node 404 to run vendor resources, such as programs and applications directly on the user node 404. The node manager application 416 further allows for the storage of any electronic data or electronic data sets that the user 202 may have generated while using a vendor resource.

FIG. 4b illustrates a hybrid method of the robust cloud computing e-discovery system environment 700, in accordance with an embodiment of the invention. As illustrated in FIG. 4b, a hybrid RCCEP system environment 700 provides vendor resources 702 and user silos 704 to be located within the cloud 201. In this way, the user 202 may have access to the vendor resources 702 on the cloud 201 through the user silo 704. The user silo 704 is a portion of the cloud 201 that is securely accessed by only that user 202 or entities associated with that user 202. In this way, the user 202 may access the vendor resources 702 through the portal created by the user silo 704. The user silos 704 may also store any data the user 202 desires that may be associated with the user's 202 e-discovery process. The security risks associated with vendor resources reside outside a host firewall, such as the risk of third party gaining access to the RCCEP system, may be minimized because each user 202 may have private access to its own dedicated user node 404.

As illustrated in FIG. 4b, vendor systems 206 provide the e-discovery technology data, in the form of vendor resources, required for all of the phases of the e-discovery process to the cloud 201, as further described above with respect to FIG. 3. Once the vendor systems 206 provide the programs, the implementation of the RCCEP program may be in a hybrid cloud environment. Vendor resources, such as programs and applications on the cloud 201 may be utilized by a user 202 through a user silo 704.

The user silo 704 allows a user 202 direct access to the vendor resources 702 that are on the cloud 201. The user 202 may be able access, leverage, and use any vendor resources 702 on the cloud 201 through the user silo 704. Furthermore, the user silo 704 allows the user 202 to store data, such as initial e-discovery data, data sets created by utilizing vendor resources 702, or other e-discovery data within the user silo 704 securely, without third party access to the data. In this way, the user silo 704 provides a secure means of accessing the vendor resources 702 and storing data on the cloud 201 for a user 202.

As further illustrated in FIG. 4b, a user 202 may access the user silo 704 of a cloud 201 via a user system 204. The user system 204 is described in further detail above with respect to FIG. 3. In this embodiment, the user system 206 is illustrated as a mobile device, such that a user 202 may be able to access the cloud 201 using a mobile device. The embodiment illustrated in FIG. 4b depicts 4 vendor systems 206 and three user systems 204, one of ordinary skill in the art will appreciate that multiple vendor systems 206 or multiple user systems 204 may be utilized. Furthermore, with each additional user system 206 accessing the cloud 201, a new user silo 704 may be created for that new user 202 to be able to access the vendor resources 702 and store data using the user silo 704.

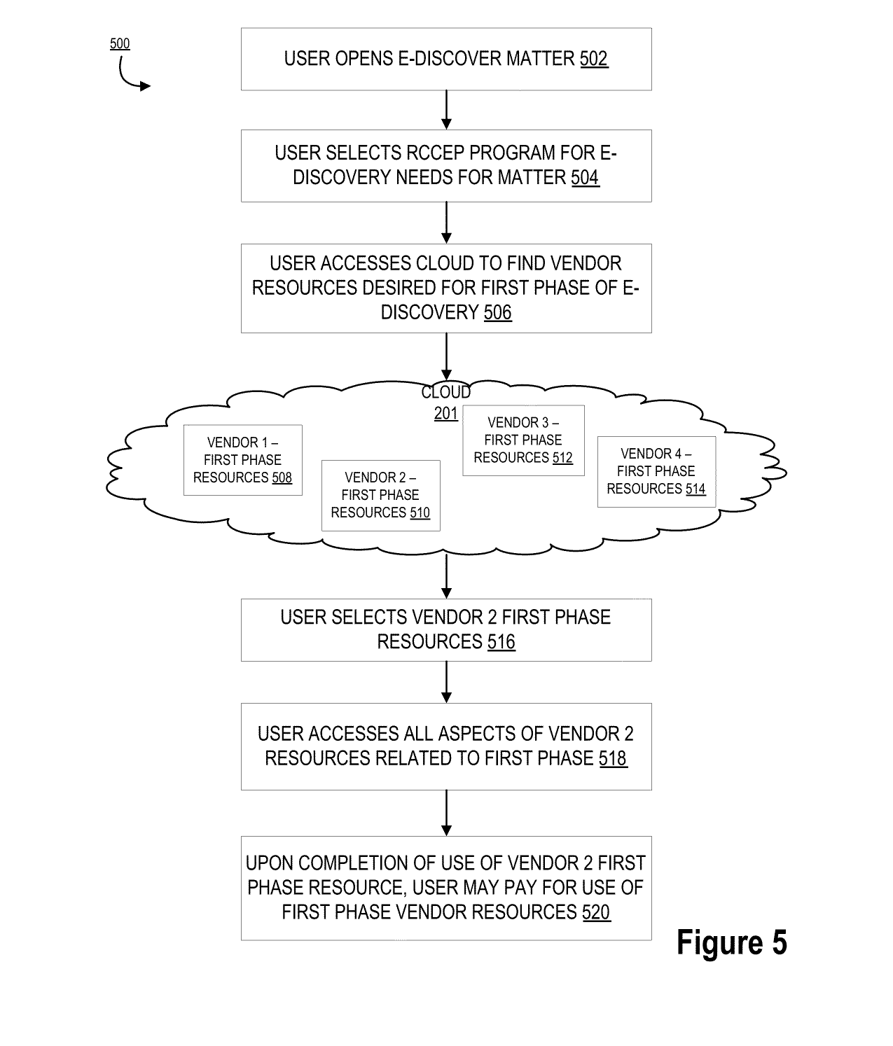

FIG. 5 illustrates a process map of a user's navigation of the robust cloud computing e-discovery platform 500, in accordance with an embodiment of the invention. As illustrated in block 502, the user 202 opens an e-discovery matter. The user 202 may be an individual, law firm, financial institution, government organization, corporation, or other entity that may require e-discovery resources for a pending lawsuit. In this way, the user 202 may be in the stage of the lawsuit that may require discovery of documents and the like. The user 202 at that point may determine that the proper discovery means for that particular matter may be e-discovery. The user 202 may open an e-discovery matter with a vendor, internally, with a client, and/or the like.

Once the user 202 has decided to approach a lawsuit by opening an e-discovery matter in block 502, the user may select the RCCEP system for his/her e-discovery needs, as illustrated in block 504. In some embodiments, the user 202 may opt-in to the RCCEP program. In this way, the host of the RCCEP system may monitor the users that have access to the cloud 201 as well as accept or deny users 202 access to the cloud 201. This may be an added security feature to the cloud 201 to better eliminate third parties from accessing the cloud 201 without the permission of the host of the RCCEP system. The user 202 may be able to, in some embodiments, access vendor resources and/or store data via a user silo 704 on the cloud 201. Furthermore, the user 202 may, in some embodiments, elect to set up a user node 404 for utilizing the RCCEP system.

As illustrated in block 506, after the user 202 has selected the RCCEP program for his/her e-discovery requirement and, if necessary, has set up a user node 404, the user 202 may access the cloud 201 to find vendor resources the user 202 desires to use during his/her e-discovery process. Furthermore, the user 202 may wish to set up a user silo 704 on the cloud 201. In block 506 the user 202 may find the vendor resources he/she wishes to use for the first phase of e-discovery. The user 202 may access the cloud 201 where the user 202 may select vendor resources from all vendors that have resources on the cloud 201. FIG. 5 illustrates the cloud 202 having vendor resources for the first phase of e-discovery from vendor 1 508, vendor 2 510, vendor 3 512, and vendor 4 514. Therefore, in this example, four separate vendors have provided resources that may be utilized during the first phase of e-discovery.

Once the user 202 has access to the cloud 201, he/she may be able to see which vendor resources are available for the specific phase of e-discovery the user 202 is wishing to utilize the cloud 201. The vendor resources available may include brief descriptions, previews, free trial periods, etc. such that the user 202 may be able to determine which vendor resource may be best for the user's needs for each phase of e-discovery. As illustrated in block 516, the user 202, in this instance, selects vendor 2 program for the first phase of e-discovery. Vendor 2 may provide vendor resources, such as a program or an application that the user 202 has determined may provide the best results for that phase of e-discovery.

The user 202 selected the first phase e-discovery resources from vendor 2 in block 516. After that selection, the user 202 may have access to all of the vendor 2 resources, including any applications and programs associated with the vendor's first phase vendor resources, as illustrated in block 518. In some embodiments, the user 202 may access and use the vendor's first phase vendor resources via the processing capabilities of a user device 204. In this way, the user 202 can use his/her own computing device to run the vendor resources. In other embodiments, the user 202 may access and use the vendor's first phase vendor resources via the processing capabilities of the cloud 201. In this way, the user 202 can use the capabilities of the cloud 201 to run the vendor resources, such as utilizing a user silo 704 on the cloud 201. In yet other embodiments, the user 202 may access and use the vendor's first phase vendor resources via the processing capabilities of a user node 404. In this way, the user 202 can use the capabilities of the user node 404 to run the vendor resources. The user device 204, the cloud 201, and the user node 404 may all be capable of storing the electronic data or electronic data sets that the user 202 may have created by using the vendor resources for the first phase of e-discovery.

Once the user 202 has completed using the vendor's resources for the first phase of e-discovery, the user 202 may pay for the use of the vendor's resources, as illustrated in block 520. The fees associated with the user's use of the vendor resources may in some embodiments, be established by the vendor. In other embodiments, the host of the RCCEP program may establish the fees to charge a user 202. In this way, the host of the RCCEP program may establish a payment agreement with the vendor, prior to charging the user 202 for use of the cloud 201. When the vendor is allowed to set fees for the user 202, this may be done in several ways. In some embodiments, the vendor may change a user 202 based on the user's use of the vendor's resources. In some embodiments, the vendor may charge a user 202 a fixed fee for using the vendor's resources. In yet other embodiments, the vendor may charge a user 202 based on the amount of time the user 202 uses the vendor's resources. When the host of the RCCEP program establishes the fees to charge the user 202, the vendor will not directly charge the user 202 for use of the vendor resources. In this way, the user 202 may be charged a set fee from the RCCEP system host, such as a financial institution, based on the user's 202 use of the RCCEP program. The fee will then be distributed back to the vendors that populated the cloud 201 with vendor resources.

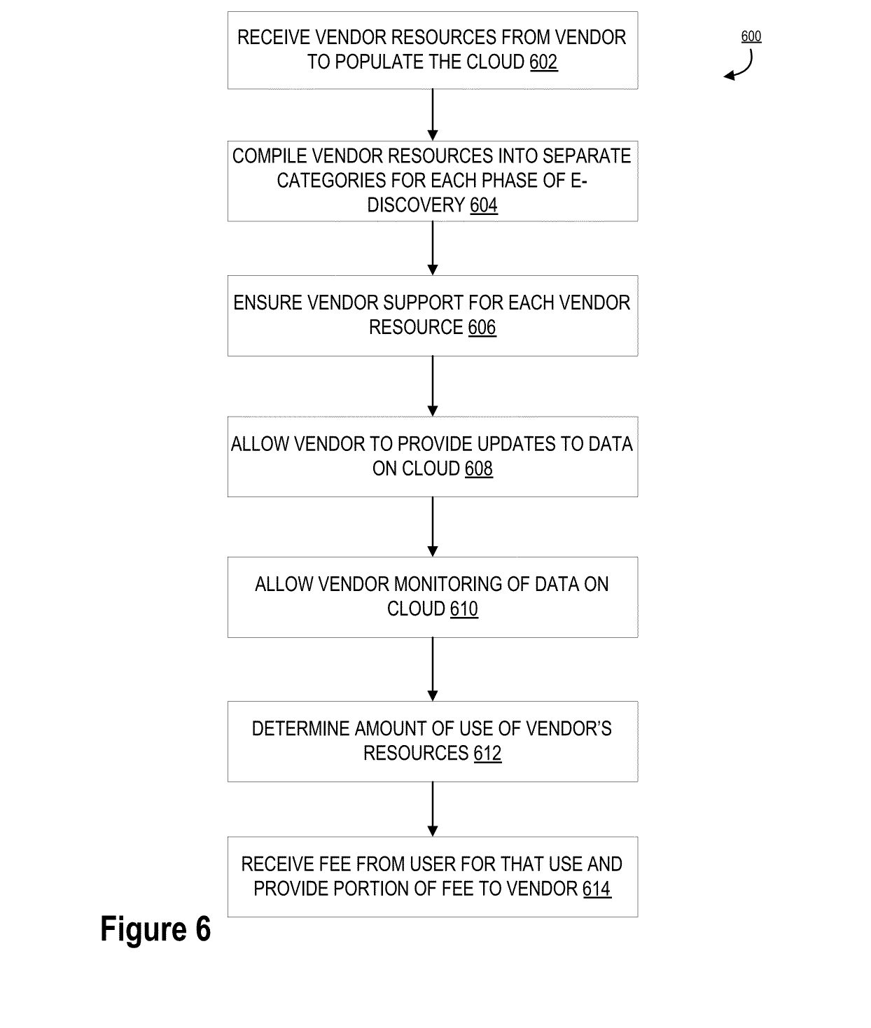

FIG. 6 illustrates a process map of a vendor access and use of the robust cloud computing e-discovery platform 600, in accordance with an embodiment of the invention. As illustrated in block 602, the vendor may populate the cloud 201 with vendor resources. These resources may be received by the RCCEP system in the form of bundles of vendor resources. As such, the RCCEP system may have to, as illustrated in block 604 compile the vendor resources into separate categories for each phase of e-discovery. In this way, each individual application, program, or the like within the vendor resources bundle may be searched for by a use 202 based on the user 202 desired e-discovery phase. The system then ensures that the vendor resources may each be supported by the cloud 201, as illustrated in block 606. In this way, the system ensures that no matter the vendor or user 202 operating system or compatibility issues, the vendor and user 202 may be able to access, use, and store information using the cloud 201. Furthermore, the vendor is provided access to the cloud 201 in order to provide necessary updates, patches, etc. to the resources the vendor has provided to the cloud 201.

At any time after the initial placement of resources on the cloud 201 the RCCEP system may, as illustrated in block 612, determine the amount of use of vendor's resources 612. The amount of use of the vendor's resources may be the amount of time a user 202 used the resources, the number of requests for the vendor resources, the number of times a user 202 selected the vendor resources, and/or the like. In this way, the vendor may be able to determine which of their resources are being utilized by users 202 the most and which ones may need improvement based on the monitoring of the cloud 201.

Once the user 202 has completed using the vendor's resources for the particular phase of e-discovery, in some embodiments the user 202 may receive a fee from the host of the RCCEP system. In this way, the RCCEP system may receive a payment from a user 202 for the use's use of the vendor resources and, subsequently, a portion of that fee may be provided to the vendor that populated the cloud 201 with the resources used.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing e-discovery resources to a user, the method comprising:
receiving e-discovery resources at a platform, wherein the e-discovery resources are provided to the platform by vendors;
storing, via a computing device, e-discovery resources on the platform based at least in part on a phase of e-discovery associated with the resource;
receiving an indication that the user is initiating an e-discovery phase;
providing the user with access to the platform, based at least in part on the user initiating an e-discovery phase, wherein the user may access the e-discovery resources available on the platform;
allowing the user to select e-discovery resources on the platform based on e-discovery phase; and
determining a fee for the user's use of the platform and e-discovery resources available on the platform.

2. The method of claim 1 wherein the phases of e-discovery address one or more of identification, collection, preservation, review, and product of electronic data for use in a lawsuit.

3. The method of claim 1 wherein providing the user with access to the platform further comprises establishing a private platform wherein only the user has access to the e-discovery resources populating the platform.

4. The method of claim 1 further comprising storing electronic data created by the user when the user accesses the e-discovery resources available on the platform

5. The method of claim 1 wherein the platform comprises a cloud, wherein the cloud allows for real-time access to a shared pool of e-discovery resources.

6. The method of claim 5 wherein a financial institution hosts the cloud.

7. The method of claim 1 further comprising:
allowing the user to select an individual e-discovery resource for a first phase of e-discovery based on the phase of e-discovery; and
allowing the user to select an individual e-discovery resource for a second phase of e-discovery independent of the e-discovery resource selected for the first phase of e-discovery.

8. The method of claim 1 further comprising:
allowing the user to select an individual e-discovery resource from the platform, wherein the e-discovery resource is from a first vendor; and
allowing the user to select a second individual e-discovery resource from the platform, wherein the e-discovery resource is from a second vendor.

9. The method of claim 1 wherein the user is a party of a lawsuit requiring e-discovery.

10. The method of claim 1 wherein the user is a representative of a party of a lawsuit requiring e-discovery.

11. The method of claim 1 wherein e-discovery resources further comprise applications that assist the user in one or more phases of e-discovery.

12. The method of claim 1 wherein e-discovery resources further comprise programs that assist the user in one or more phases of e-discovery.

13. The method of claim 1 wherein allowing the user to select e-discovery resources on the platform based on e-discovery phase further allows the user access to the cloud though a user silo.

14. The method of claim 13 wherein the user silo allows the user to access the e-discovery resources on the cloud securely.

15. The method of claim 13 wherein the user silo allows the user to store electronic data on the cloud securely.

16. The method of claim 1 wherein determining a fee for the user's use of the platform and e-discovery resources available on the platform further comprising determining a flat fee for the use of the platform.

17. A system for providing e-discovery resources to a user, the system comprising:
a memory device;
a communication device; and
a processing device operatively coupled to the memory device and the communication device, wherein the processing device is configured to execute computer-readable program code to:
receive e-discovery resources at a platform, wherein the e-discovery resources are provided to the platform by vendors;
store e-discovery resources on the platform based at least in part on a phase of e-discovery associated with the resource;
receive an indication that the user is initiating an e-discovery phase;
provide the user with access to the platform, based at least in part on the user initiating an e-discovery phase, wherein the user may access the e-discovery resources available on the platform;
allow the user to select e-discovery resources on the platform based on e-discovery phase; and
determine a fee for the user's use of the platform and e-discovery resources available on the platform.

18. The system of claim 17 wherein the phases of e-discovery address one or more of identification, collection, preservation, review, and product of electronic data for use in a lawsuit.

19. The system of claim 17 wherein providing the user with access to the platform further comprises establishing a private platform wherein only the user has access to the e-discovery resources populating the platform.

20. The system of claim 17 further comprising storing electronic data created by the user when the user accesses the e-discovery resources available on the platform

21. The system of claim 17 wherein the platform comprises a cloud, wherein the cloud allows for real-time access to a shared pool of e-discovery resources.

22. The system of claim 21 wherein a financial institution hosts the cloud.

23. The system of claim 17 wherein the processing device is further configured to:
allow the user to select an individual e-discovery resource for a first phase of e-discovery based on the phase of e-discovery; and
allow the user to select an individual e-discovery resource for a second phase of e-discovery independent of the e-discovery resource selected for the first phase of e-discovery.

24. The system of claim 17 wherein the processing device is further configured to:
allow the user to select an individual e-discovery resource from the platform, wherein the e-discovery resource is from a first vendor; and
allow the user to select a second individual e-discovery resource from the platform, wherein the e-discovery resource is from a second vendor.

25. The system of claim 17 wherein the user is a party of a lawsuit requiring e-discovery.

26. The system of claim 17 wherein the user is a representative of a party of a lawsuit requiring e-discovery.

27. The system of claim 17 wherein e-discovery resources further comprise applications that assist the user in one or more phases of e-discovery.

28. The system of claim 17 wherein e-discovery resources further comprise programs that assist the user in one or more phases of e-discovery.

29. The system of claim 17 wherein allowing the user to select e-discovery resources on the platform based on e-discovery phase further allows the user access to the cloud though a user silo.

30. The system of claim 29 wherein the user silo allows the user to access the e-discovery resources on the cloud securely.

31. The system of claim 29 wherein the user silo allows the user to store electronic data on the cloud securely.

32. The system of claim 17 wherein determining a fee for the user's use of the platform and e-discovery resources available on the platform further comprising determining a flat fee for the use of the platform.

33. A computer program product for providing e-discovery resources to a user, the computer program product comprising at least one non-transitory computer-readable medium having computer-readable program codes portions embodied therein, the computer-readable program code portions comprising:
An executable portion configured for receiving e-discovery resources at a platform, wherein the e-discovery resources are provided to the platform by vendors;
An executable portion configured for storing e-discovery resources on the platform based at least in part on a phase of e-discovery associated with the resource;
An executable portion configured for receiving an indication that the user is initiating an e-discovery phase;
An executable portion configured for providing the user with access to the platform, based at least in part on the user initiating an e-discovery phase, wherein the user may access the e-discovery resources available on the platform;
An executable portion configured for allowing the user to select e-discovery resources on the platform based on e-discovery phase; and
An executable portion configured for determining a fee for the user's use of the platform and e-discovery resources available on the platform.

34. The computer program product of claim 33 wherein the phases of e-discovery address one or more of identification, collection, preservation, review, and product of electronic data for use in a lawsuit.

35. The computer program product of claim 33 wherein providing the user with access to the platform further comprises establishing a private platform wherein only the user has access to the e-discovery resources populating the platform.

36. The computer program product of claim 33 further comprising storing electronic data created by the user when the user accesses the e-discovery resources available on the platform

37. The computer program product of claim 33 wherein the platform comprises a cloud, wherein the cloud allows for real-time access to a shared pool of e-discovery resources.

38. The computer program product of claim 37 wherein a financial institution hosts the cloud.

39. The computer program product of claim 33 further comprising:
An executable portion configured for allowing the user to select an individual e-discovery resource for a first phase of e-discovery based on the phase of e-discovery; and
An executable portion configured for allowing the user to select an individual e-discovery resource for a second phase of e-discovery independent of the e-discovery resource selected for the first phase of e-discovery.

40. The computer program product of claim 33 further comprising:
An executable portion configured for allowing the user to select an individual e-discovery resource from the platform, wherein the e-discovery resource is from a first vendor; and
An executable portion configured for allowing the user to select a second individual e-discovery resource from the platform, wherein the e-discovery resource is from a second vendor.

41. The computer program product of claim 33 wherein the user is a party of a lawsuit requiring e-discovery.

42. The computer program product of claim 33 wherein the user is a representative of a party of a lawsuit requiring e-discovery.

43. The computer program product of claim 33 wherein e-discovery resources further comprise applications that assist the user in one or more phases of e-discovery.

44. The computer program product of claim 33 wherein e-discovery resources further comprise programs that assist the user in one or more phases of e-discovery.

45. The computer program product of claim 33 wherein allowing the user to select e-discovery resources on the platform based on e-discovery phase further allows the user access to the cloud though a user silo.

46. The computer program product of claim 45 wherein the user silo allows the user to access the e-discovery resources on the cloud securely.

47. The computer program product of claim 45 wherein the user silo allows the user to store electronic data on the cloud securely.

48. The computer program product of claim 33 wherein determining a fee for the user's use of the platform and e-discovery resources available on the platform further comprising determining a flat fee for the use of the platform.
